(19) United States
(12) Patent Application Publication
(10) Pub. No.: US 2019/0389267 A1
(43) Pub. Date: Dec. 26, 2019

(54) SUSPENSION DEVICE AND SUSPENSION CONTROL DEVICE

(71) Applicant: KYB CORPORATION, Tokyo (JP)

(72) Inventors: Hiroyuki KOJIMA, Tokyo (JP); Koichiro AWANO, Tokyo (JP)

(73) Assignee: KYB CORPORATION, Tokyo (JP)

(21) Appl. No.: 16/479,086

(22) PCT Filed: Apr. 12, 2018
(86) PCT No.: PCT/JP2018/015331

§ 371 Date: Jul. 18, 2019

(30) Foreign Application Priority Data
Apr. 28, 2017 (JP) 2017-089234

(51) Int. Cl. B60G 13/08; B60G 17/015

(52) U.S. Cl. CPC B60G 13/08; B62K 25/04; B60G 17/015

(57) ABSTRACT

A suspension device of the present invention includes a front wheel-side damper damping force of which is adjustable and which is placed between a vehicle body and a front wheel in a saddled vehicle, a rear wheel-side damper damping force of which is adjustable and which is placed between the vehicle body and a rear wheel, and a control device to control the damping force of the front wheel-side damper and the rear wheel-side damper. Responsiveness in a damping force adjustment of the front wheel-side damper is made higher than responsiveness in a damping force adjustment of the rear wheel-side damper.

### TECHNICAL FIELD

The present invention relates to a suspension device and a suspension control device.

### BACKGROUND ART

For example, as disclosed in JP 2017-030577 A, a suspension device including a front wheel-side damper and a rear wheel-side damper with variable damping force between a vehicle body and front and rear wheels of a vehicle includes a control device that controls the damping force of the front wheel-side damper and the rear wheel-side damper in response to a position change of the vehicle body (see, for example, Patent Literature 1).

### SUMMARY OF THE INVENTION

In such a suspension device, a front wheel-side damper and a rear wheel-side damper have the same configuration, and circuit configurations in a control device which configurations respectively correspond to the front wheel-side damper and the rear wheel-side damper have similar configurations.

Here, in a case of a saddled vehicle, the front wheel-side damper has a longer stroke length than the rear wheel-side damper. When responsiveness in a damping force adjustment of the front wheel-side damper is low, it takes time to optimize damping force of the front wheel-side damper and there is a case where a riding posture of a passenger is disturbed and riding comfort is deteriorated. In such a manner, high responsiveness in the damping force adjustment is required to the front wheel-side damper. However, in a conventional suspension device, what can provide the same responsiveness with the front wheel-side damper is used as the rear wheel-side damper.

Thus, the conventional suspension device, or a suspension control device used in the suspension device is very expensive and a reduction of a cost is demanded.

Thus, the present invention is to provide a suspension device and a suspension control device with which a cost can be reduced while riding comfort in a saddled vehicle is secured.

In order to achieve the above purpose, a suspension device of the present invention includes: a front wheel-side damper damping force of which is adjustable and which is placed between a vehicle body and a front wheel of a saddled vehicle; a rear wheel-side damper damping force of which is adjustable and which is placed between the vehicle body and a rear wheel; and a control device to control the damping force of the front wheel-side damper and the rear wheel-side damper, wherein responsiveness in the damping force adjustment of the front wheel-side damper is set higher than responsiveness in the damping force adjustment of the rear wheel-side damper.

Also, in order to achieve the above purpose, a suspension control device of the present invention includes: a front wheel-side driving circuit to drive a front wheel-side solenoid valve that adjusts damping force in a front wheel-side damper placed between a vehicle body and a front wheel in a saddled vehicle; and a rear wheel-side driving circuit to drive a rear wheel-side solenoid valve that adjusts damping force in a rear wheel-side damper placed between the vehicle body and a rear wheel, wherein a degaussing circuit to degauss a solenoid in the front wheel-side solenoid valve is provided only in the front wheel-side driving circuit.

### BRIEF DESCRIPTION OF DRAWINGS

FIG. 1 is a schematic configuration view of a suspension device in one embodiment applied to a two-wheeled vehicle.

FIG. 2 is a schematic view of a front wheel-side damper and a rear wheel-side damper of the suspension device in the one embodiment.

FIG. 3 is a view illustrating a driving circuit of a front wheel-side solenoid valve.

FIG. 4 is a view illustrating a driving circuit of a rear wheel-side solenoid valve.

FIG. 5 is a view illustrating a transition of current flowing in a solenoid to which current is supplied from the driving circuit of the rear wheel-side solenoid valve.

FIG. 6 is a view for describing an operation of the driving circuit of the front wheel-side solenoid valve of when degaussing of a solenoid is performed.

FIG. 7 is a view illustrating a transition of current flowing in the solenoid to which current is supplied from the driving circuit of the front wheel-side solenoid valve.

### DESCRIPTION OF EMBODIMENTS

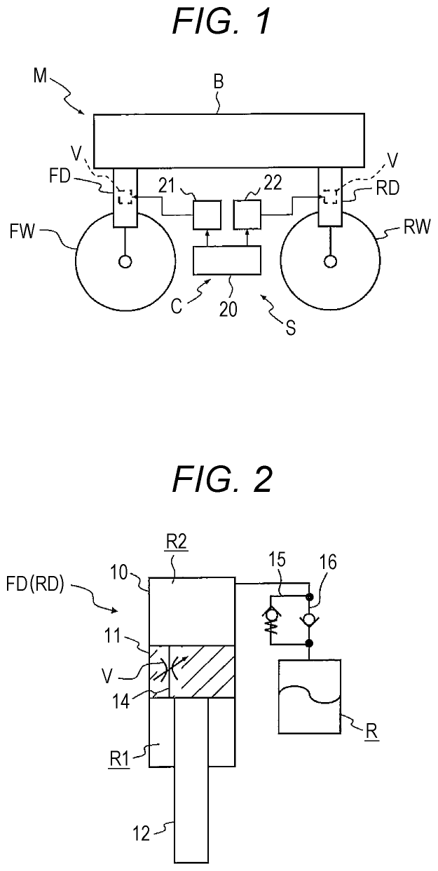

In the following, the present invention will be described based on an embodiment illustrated in the drawings. As illustrated in FIG. 1, in this example, a suspension device S in one embodiment includes a front wheel-side damper FD damping force of which is adjustable and which is placed between a vehicle body B and a front wheel FW of a two-wheeled vehicle M as a saddled vehicle, a rear wheel-side damper RD damping force of which is adjustable and which is placed between the vehicle body B and a rear wheel RW, and a control device C as a suspension control device to control the damping force in these front wheel-side damper FD and rear wheel-side damper RD. Although being the two-wheeled vehicle M in the present example, the saddled vehicle only needs to be a vehicle in which a passenger sits on a saddle and may be a tricycle or a four-wheeled buggy.

In the following, each member will be described in detail. As illustrated in FIG. 2, each of the front wheel-side damper FD and the rear wheel-side damper RD, for example, includes a cylinder 10, a piston 11 that is slidably inserted into the cylinder 10 and that divides the cylinder 10 into an extension-side chamber R1 and a pressure-side chamber R2 filled with liquid, a piston rod 12 that is also inserted into the cylinder 10 movably and is coupled to the piston 11, a tank 13 including, in an inner part, a reservoir R communicating with the pressure-side chamber R2, a damping path 14 that makes the extension-side chamber R1 and the pressure-side chamber R2 communicate with each other, a discharge path 15 that applies resistance to a flow of liquid from the pressure-side chamber R2 toward the reservoir R, an inlet path 16 that only permits a flow of liquid from the reservoir R toward the pressure-side chamber R2, and a solenoid valve V that is provided in the damping path 14 and that performs a damping force adjustment. Here, the extension-side chamber R1 and the pressure-side chamber R2 are filled with liquid, and the reservoir R is filled with gas and liquid. As liquid, not only a hydraulic oil but also other liquid such as water or a solution can be used.

Also, in the present example, the front wheel-side damper FD is housed in an extendable/contractable telescopic-type hollow front fork, which suspends the front, wheel FW on the vehicle body B, and is placed between the front wheel FW and the vehicle body B although not illustrated. The front fork is coupled to a steering wheel (not illustrated) of the two-wheeled vehicle M, and steering of the front wheel FW can be performed by steering wheel operation by a passenger. Also, although not illustrated, the rear wheel-side damper RD is placed between the vehicle body B and an arm that supports the rear wheel RW slidably with respect to this vehicle body B in the present example. In the present example, the front wheel-side damper FD and the rear wheel-side damper RD are installed in the two-wheeled vehicle M in such a manner that a leading end of the piston rod 12 is coupled to the front wheel FW and the rear wheel RW of the two-wheeled vehicle M and the cylinder 10 is coupled to the vehicle body B of the two-wheeled vehicle. Note that in a case where the gas and liquid in the reservoir R are separated by an elastic bulkhead or a sliding bulkhead, the front wheel-side damper FD and the rear wheel-side damper RD may be installed in an upside-down manner of FIG. 2 in the two-wheeled vehicle M.

The solenoid valve V is, for example, a solenoid valve in which a valve body is driven by a solenoid. A flow channel area is changed by an adjustment of a valve body position with an amount of supplied current, whereby resistance applied to the liquid flowing in the damping path 14 is changed. The solenoid valve V may be a variable throttle that can adjust the flow channel area in such a manner or a pressure-regulating valve that regulates a valve opening pressure.

Then, in a case where these front wheel-side damper FD and rear wheel-side damper RD perform extending action, liquid moves from the compressed extension-side chamber R1 to the expanded pressure-side chamber R2 through the damping path 14. At that time, the liquid passes through the solenoid valve V and the solenoid valve V applies resistance to a flow of the liquid. Thus, differential pressure is generated between the extension-side chamber R1 and the pressure-side chamber R2. The front wheel-side damper FD and the rear wheel-side damper RD provide extension-side damping force to suppress the extending action according to this differential pressure. Note that the liquid is supplied from the reservoir R to the inside of the expanded pressure-side chamber R2 through the inlet path 16, and volume of the piston rod 12 retracted from the cylinder 10 is compensated. The differential pressure between the extension-side chamber R1 and the pressure-side chamber R2 can be adjusted by the solenoid valve V, damping force generated by the front wheel-side damper FD and the rear wheel-side damper RD during the extending action can be adjusted by the solenoid valve V.

On the other hand, in a case where the front wheel-side damper FD and the rear wheel-side damper RD perform contracting action, liquid moves from the compressed pressure-side chamber R2 to the expanded extension-side chamber R1 through the damping path 14. Also, since the piston rod 12 moves into the cylinder 10, excessive liquid in the cylinder 10 is discharged from the pressure-side chamber R2 to the reservoir R through the discharge path 15. In such a manner, liquid corresponding to volume of the piston rod 12 that moves into the cylinder 10 is discharged from the cylinder 10 to the reservoir R, and the volume of the piston rod 12 that moves into the cylinder 10 is compensated. Then, in a case where the front wheel-side damper FD and the rear wheel-side damper RD perform the contracting action, the discharge path 15 and the solenoid valve V apply resistance to movement of the liquid. Thus, pressure inside the cylinder 10 is increased and differential pressure is generated between the pressure-side chamber R2 and the extension-side chamber R1. Thus, in a case of performing the contracting action, the front wheel-side damper FD and the rear wheel-side damper RD provide pressure-side damping force to suppress the contracting action according to a pressure increase in the cylinder 10 and the differential pressure between the pressure-side chamber R2 and the extension-side chamber R1. Since the differential pressure between the pressure-side chamber R2 and the extension-side chamber R1 can be adjusted by the solenoid valve V, damping force generated by the front wheel-side damper FD and the rear wheel-side damper RD during the contracting action can be adjusted by the solenoid valve V.

Note that the front wheel-side damper RD and the rear wheel-side damper RD are not limited to the above configuration. In a case of a magnetic viscous damper in which a hydraulic liquid is a magnetic viscous fluid, a coil to apply a magnetic field to a damping path 14 during energization only needs to be provided instead of the solenoid valve V.

As illustrated in FIG. 1, the control device C includes a control unit 20 that calculates a target value of damping force provided by the front wheel-side damper FD and the rear wheel-side damper RD and that generates a current command of instructing an amount of current supplied to each solenoid valve V in the front wheel-side damper FD and the rear wheel-side damper RD, and driving circuits 21 and 22 that supply current to a solenoid of each solenoid valve V according to the current command.

For example, the control unit 20 monitors a position of the vehicle body B, reduces pitching or squat of the two-wheeled vehicle M, or calculates, as a target value, damping force to be provided by the front wheel-side damper FD and the rear wheel-side damper RD to suppress a vibration of the vehicle body B. For the monitoring of a position of the vehicle body B, a gyroscope sensor, an acceleration sensor, or a stroke sensor to detect an extension/contraction displacement of the forward and rear dampers FD and RD, the sensor being installed in the vehicle body B, is used.

Also, when calculating the target value of the damping force, the control unit 20 calculates, from the target value, an amount of current supplied to each of the solenoid valves V of the front wheel-side damper FD and the rear wheel-side damper RD and generates a current command. In generation of the current command, for example, the control unit 20 previously grasps a relationship between an amount of current and damping force provided by the front wheel-side damper FD and the rear wheel-side damper RD, and generates a current command by calculating the amount of current from a value of the target damping force.

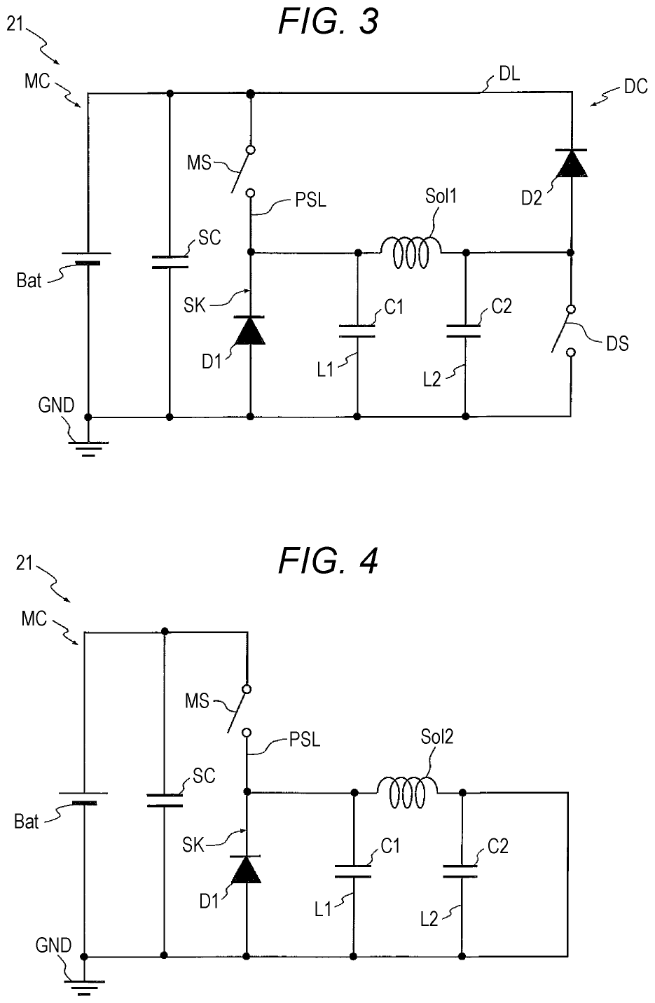

As illustrated in FIG. 3, the driving circuit 21 to drive a front wheel-side solenoid valve V, that is, the solenoid valve V in the front wheel-side damper FD includes a main circuit MC to perform PWM driving of a solenoid Sol1 of the front wheel-side solenoid valve V, and a degaussing circuit DC to degauss the solenoid Sol1. On the other hand, as illustrated in FIG. 4, the driving circuit 22 to drive a rear wheel-side solenoid valve V, that is, the solenoid valve V in the rear wheel-side damper RD only includes a main circuit MC to perform PWM driving of a solenoid Sol2 of the rear wheel-side solenoid valve V. That is, the driving circuit 21 of the front wheel-side solenoid valve V has a circuit configuration in which the degaussing circuit DC is added to a circuit configuration of the driving circuit 22 of the rear wheel-side solenoid valve V. Thus, first, the driving circuit 22 that only includes the main circuit MC and that drives the rear wheel-side solenoid valve V will be described in detail.

As illustrated in FIG. 4, the driving circuit 22 of the rear wheel-side solenoid valve V only includes the main circuit MC that supplies electric power to the solenoid Sol2 in order to perform PWM driving of the rear wheel-side solenoid valve V. The main circuit MC includes a power supply line PSL to connect one end of the solenoid Sol2 to a power supply Bat and to ground the other end thereof to ground GND, a main switch MS including an N-channel MOSFET provided between the solenoid Sol2 and the power supply Bat in the middle of the power supply line PSL, a surge killer SK that includes a diode D1 and that is placed between the main switch MS and the solenoid Sol2 in the power supply line PSL, and the ground GND with a direction from a ground side toward a power supply side being a forward direction, a first line L1 and second line L2 that connect both sides of the solenoid Sol2 in the power supply line PSL and the ground GND, a first capacitor C1 for a noise removal which capacitor is placed in the first line L1, and a second capacitor C2 for a noise removal which capacitor is placed in the second line L2, and a smoothing capacitor SC placed between the power supply Bat and the surge killer SK, and the ground GND. Also, although not illustrated, the driving circuit 22 includes a switch control unit that receives a control command from the control unit 20 and that performs switching control of the main switch MS.

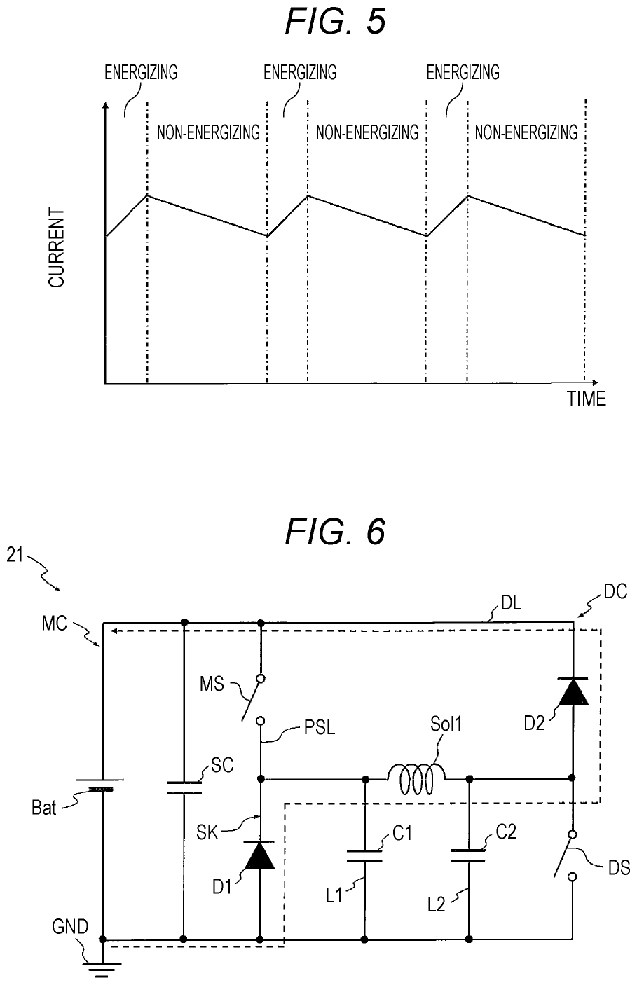

The main circuit MC configured in such a manner can supply electric power from the power supply Bat to the solenoid Sol2 when the main switch MS is closed, and energization from the power supply Bat to the solenoid Sol2 is interrupted when the main switch MS is opened. When the main switch MS is opened in a state in which the main switch MS is closed and electric power is supplied to the solenoid Sol2, back electromotive force is generated in the solenoid Sol2. However, the surge killer SK functions and generation of an excessive surge in the solenoid Sol2 is prevented, whereby current flowing in the solenoid Sol2 is gradually dropped. More specifically, as illustrated in FIG. 5, the solenoid Sol2 is applied and current is increased when the main switch MS is turned on and the solenoid Sol2 is energized, and the current flowing in the solenoid Sol2 is gradually decreased when the main switch MS is turned off. Thus, a current adjustment is performed by switching of the main switch MS according to current intended to flow in the solenoid Sol2.

Thus, when a current command is given from the control unit 20, the driving circuit 22 applies voltage to the solenoid Sol2 in such a manner that a current value designated for the solenoid Sol2 by the current command is acquired. To adjust the voltage applied to the solenoid Sol2 in such a manner as to acquire the current value following the current command, the driving circuit 22 sets an ON-duty ratio of the main switch MS in such a manner that the current flowing in the solenoid Sol2 follows the current command and switches the main switch MS. In such a manner, the driving circuit 22 performs PWM driving of the solenoid valve V by switching the main switch MS and adjusting the voltage applied to the solenoid Sol2. Note that voltage transmitted from the power supply Bat to a side of the main switch MS is smoothed by the smoothing capacitor SC. Thus, the driving circuit 22 can accurately control the voltage applied to the solenoid Sol2 even when an output voltage of the power supply Bat varies.

On the other hand, as illustrated in FIG. 3, the driving circuit 21 of the front wheel-side solenoid valve V includes the degaussing circuit DC to degauss the solenoid Sol1 in addition to the main circuit MC that supplies electric power to the solenoid Sol1 in order to perform PWM driving of the front wheel-side solenoid valve V. The main circuit MC has a configuration similar to that of the main circuit MC in the driving circuit 22 of the rear wheel-side solenoid valve V.

The degaussing circuit DC includes a degaussing switch DS including an N-channel MOSFET provided between the solenoid Sol1 and the ground GND in the middle of the power supply line PSL in the main circuit MC, a degaussing line DL that is in the middle of the power supply line PSL and that connects the main switch MS and the power supply Bat, and the solenoid Sol1 and the degaussing switch DS, a degaussing diode D2 provided in the middle of the degaussing line DL with a direction from a ground side toward a power supply side being a forward direction, and a smoothing capacitor SC placed between the power supply Bat and the surge killer SK, and the ground GND. Also, although not illustrated, the driving circuit 21 includes a switch control unit that receives an input of a control command from the control unit 20 and that performs switching control of the main switch MS and the degaussing switch DS.

In a state of being closed, the degaussing switch DS installs the solenoid Sol1 in the ground GND. Thus, when the degaussing switch DS is in an ON-state, the driving circuit 21 can adjust voltage applied to the solenoid Sol1 by switching the main switch MS provided in the power supply line PSL similarly to the driving circuit 22. Thus, in a case of adjusting a current value of the solenoid Sol1 to a current value designated by a current command input from the control unit 20, the driving circuit 21 basically keeps the degaussing switch DS in the ON-state. Then, to adjust the voltage applied to the solenoid Sol1 in such a manner as to acquire the current value following the current command, the driving circuit 21 sets an ON-duty ratio of the main switch MS in such a manner that current flowing in the solenoid Sol1 follows the current command, and switches the main switch MS. In such a manner, the driving circuit 21 performs PWM driving of the solenoid valve V by switching the main switch MS and adjusting the voltage applied to the solenoid Sol1.

On the other hand, in a case of rapid degaussing of the solenoid Sol1, the main switch MS is turned off and electric power supply from the power supply Bat to the solenoid Sol1 is stopped, and the degaussing switch DS is turned off and connection between the solenoid Sol1 and the ground GND on a downstream side is cut off.

Then, as illustrated in FIG. 6, a route in which a left end of the solenoid Sol1 in FIG. 6 is connected to the ground GND through the diode D1 in the surge killer SK and a right end of the solenoid Sol1 in FIG. 6 is connected to the power supply Bat through the degaussing line DL becomes valid. In this situation, the voltage applied to the solenoid Sol1 rapidly becomes 0 by turning off of the main switch MS, and back electromotive force is generated in the solenoid Sol1. As indicated by an arrow in FIG. 6, current flows in a direction from the ground GND toward the power supply Bat in the valid circuit described above. Then, in this state, since the power supply Bat performs reverse excitation of the solenoid Sol1 in a manner opposed to the back electromotive force of the solenoid Sol1, the current flowing in the solenoid Sol1 promptly disappears and degaussing of the solenoid Sol1 is promptly performed. When degaussing of the solenoid Sol1 is performed promptly in such a manner, the front wheel-side solenoid valve V promptly returns to a position of when the solenoid Sol1 is in a non-excitation state. Note that even in a current adjustment of the solenoid Sol1 by switching of the main switch MS, in a case where it is necessary to rapidly decrease the current in the solenoid Sol1, the degaussing switch DS may be turned off along with turning off of the main switch MS and degaussing of the solenoid Sol1 may be performed.

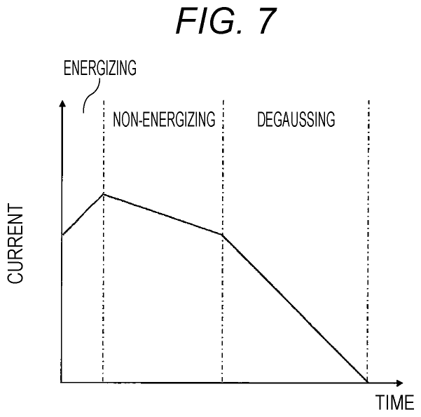

More specifically, as illustrated in FIG. 7, the solenoid Sol1 is applied and current is increased when both of the main switch MS and the degaussing switch DS are turned on and the solenoid Sol1 is energized, the current flowing in the solenoid Sol1 is gradually decreased when the main switch MS is turned off while the degaussing switch DS is kept on, and the current flowing in the solenoid Sol1 is promptly decreased when both of the main switch MS and the degaussing switch DS are turned off. In such a manner, the degaussing switch DS functions as a switch that switches validity and invalidity of the degaussing circuit DC.

Since the control unit 20 includes the above-described driving circuits 21 and 22 in such a manner, current in the solenoid Sol1 of the front wheel-side solenoid valve V is dropped more promptly than that in the solenoid Sol2 of the rear wheel-side solenoid valve V. Thus, in the suspension device S of the present example, the front wheel-side damper FD has higher responsiveness than the rear wheel-side damper RD with respect to responsiveness in the damping force adjustment.

Here, as described above, a damping force adjustment of high responsiveness is required to the front wheel-side damper FD in a case of the two-wheeled vehicle M that is a saddled vehicle. However, responsiveness in the damping force adjustment of the rear wheel-side damper RD is not required to be equivalent to that of the front wheel-side damper FD. Thus, even when the front wheel-side damper FD can perform the damping force adjustment with high responsiveness and the rear wheel-side damper RD has lower responsiveness in the damping force adjustment than the front wheel-side damper FD in a manner of the suspension device S of the present example, riding comfort in the two-wheeled vehicle M can be secured.

In such a manner, compared to a conventional suspension device in which responsiveness in a damping force adjustment of a rear wheel-side damper is equivalent to that of a front wheel-side damper, responsiveness in the damping force adjustment of the rear wheel-side damper RD can be lowered with the front wheel-side damper as a basis in the suspension device S of the present example, whereby a cost thereof is reduced and a price becomes lower. Thus, according to the suspension device S of the present example, it is possible to reduce a cost while securing riding comfort the two-wheeled vehicle (saddled vehicle) M.

Also, in the control device (suspension control device) C of the present example, the front wheel-side driving circuit 21 that drives the front wheel-side solenoid valve V to adjust damping force in the front wheel-side damper FD placed between the vehicle body B and the front wheel FW in the two-wheeled vehicle (saddled vehicle) M, and the rear wheel-side driving circuit 22 that drives the rear wheel-side solenoid valve V to adjust damping force in the rear wheel-side damper RD placed between the vehicle body B and the rear wheel RW are included, and the degaussing circuit DC to degauss the solenoid Sol1 in the front wheel-side solenoid valve V is provided only in the front wheel-side driving circuit 21. According to the control device (suspension control device) C configured in such a manner, the driving circuit 22 to drive the solenoid valve V for a damping force adjustment of the rear wheel-side damper RD has a circuit configuration with a price lower than that of the driving circuit 21 to drive the solenoid valve V for a damping force adjustment of the front wheel-side damper FD, and there is a difference in responsiveness. Thus, in the control device (suspension control device) C of the present example, it is possible to provide a difference in responsiveness in the damping force adjustment of the front wheel-side damper FD and the rear wheel-side damper RD, and to reduce a cost.

Note that in a case where each of a front wheel-side damper FD and a rear wheel-side damper RD is the above-described damper using a magnetic viscous fluid, a magnetic field applied to the magnetic viscous fluid is adjusted an amount of current applied to a coil. Thus, it is only necessary that a driving circuit 22 in which a degaussing circuit DC is omitted is used for a damping force adjustment of the rear wheel-side damper RD while a driving circuit 21 including a degaussing circuit DC is used for a damping force adjustment of the front wheel-side damper FD. In such a manner, a suspension control device has a low price and a cost of a suspension device S as a whole can be reduced.

More specifically, in the present example, the front wheel-side driving circuit 21 includes, with respect to a switch, two switches that are the main switch MS to adjusts voltage applied to the solenoid Sol1 and the degaussing switch DS to switch validity and invalidity of the degaussing circuit DC, and the rear wheel-side driving circuit 22 only includes, with respect to a switch, the main switch MS to adjust voltage applied to the solenoid Sol2. Thus, it is possible to make a price of the rear wheel-side driving circuit 22 lower than that of the front wheel-side driving circuit 21.

Also, it is possible to reduce a cost by providing a difference in responsiveness in hardware itself of the front wheel-side damper FD and the rear wheel-side damper RD. That is, it is possible to reduce a cost of the suspension device S as a whole by making the front wheel-side damper FD have a structure responding with high responsiveness to the solenoid valve V that performs the damping force adjustment, and making the rear wheel-side damper RD have a structure using the solenoid valve V with low responsiveness and a low price. Moreover, it is possible to reduce a cost of a suspension device S as a whole by making hydraulic circuit configurations of a front wheel-side damper FD and a rear wheel-side damper RD different and providing a difference in responsiveness.

Moreover, in a case where the solenoid valve V is set to increase a flow channel area when an amount of current flowing in the solenoid Sol1 becomes larger and to minimize the flow channel area in non-energization, or to make valve opening pressure lower when an amount of current flowing in the solenoid Sol1 becomes larger and to maximize the valve opening pressure in non-energization, it becomes possible to make responsiveness and damping force high in the front wheel-side damper FD. In such a manner, in a case where the front wheel-side damper FD makes the damping force high in non-energization, the front wheel-side damper FD promptly makes the damping force high in a case where it becomes impossible to supply current to the solenoid Sol1. Thus, time of a state in which the damping force is in short is reduced during a fail. Note that similarly to the front wheel-side damper FD, in a case where damping force is also made high in non-energizaton in the solenoid valve V in the rear wheel-side damper RD, damping force of the front and rear dampers FD and RD becomes high. Thus, it is possible to prevent a significant deterioration in riding comfort in a vehicle by providing the damping force even in a fail.

Also, in a case where the solenoid valve V is set to decrease a flow channel area when an amount of current flowing in the solenoid Sol1 becomes larger and to maximize the flow channel area in non-energization, or to make valve opening pressure higher when an amount of current flowing in the solenoid Sol1 becomes larger and to minimize the valve opening pressure in non-energization, it becomes possible to make responsiveness high and damping force low in the front wheel-side damper FD. In such a manner, in a case where the front wheel-side damper FD makes the damping force low in non-energization, it is possible to promptly reduce the damping force of the front wheel-side damper FD based on a Karnopp rule in a case where the vehicle body B is excited by the damping force. Thus, this is optimal for control based on the Karnopp rule.

Then, since the damping force adjustment of the front wheel-side damper FD with a long stroke length can be performed with high responsiveness, it is possible to prevent a bad influence on a riding posture of a passenger in the two-wheeled vehicle M. Thus, the suspension device S is optimal for the two-wheeled vehicle M.

Also, in each of the front wheel-side damper FD and the rear wheel-side damper RD in the suspension device S of the present example, damping force in extension and contraction can be adjusted by a single solenoid valve V. However, a damping path 14 may include an extension-side path that only permits a flow of liquid from an extension-side chamber R1 to a pressure-side chamber R2, and a pressure-side path that only permits a flow of liquid from the pressure-side chamber R2 to the extension-side chamber R1, and a solenoid valve V may be provided in each of the extension-side path and the pressure-side path. When the front wheel-side damper FD and the rear wheel side damper RD are configured in such a manner, two solenoid valves V that are a solenoid valve V providing damping force in extension and a solenoid valve V providing damping force in contraction are provided in each of the front wheel-side damper FD and the rear wheel-side damper RD. Thus, two each of front wheel-side driving circuits 21 and rear wheel-side driving circuits 22 are provided in a control device C. Also, in a case where the damping path 14 includes the extension-side path and the pressure-side path and an extension-side damping valve to switch the extension-side path and a pressure-side damping valve to switch the pressure-side path are provided, pressure of a back pressure chamber that energizes an extension-side damping valve and a pressure-side damping valve in a valve closing direction with inner pressure may be adjusted by the solenoid valve V and a damping force adjustment may be performed.

In the above, a preferred embodiment of the present invention has been described in detail. However, a reconstruction, modification, and change can be made within the scope of claims.

The present application claims priority based on Japanese Patent Application No. 2017-089234 filed in the Japan Patent Office on Apr. 28, 2017, which is incorporated herein by reference in its entirety.

1. A suspension device of a saddled vehicle, comprising:
a front wheel-side damper damping force of which is adjustable and which is placed between a vehicle body and a front wheel in the saddled vehicle;
a rear wheel-side damper damping force of which is adjustable and which is placed between the vehicle body and a rear wheel in the saddled vehicle; and
a control device that controls the damping force of the front wheel-side damper and the rear wheel-side damper, wherein
responsiveness in a damping force adjustment of the front wheel-side damper is made higher than responsiveness in a damping force adjustment of the rear wheel-side damper.

2. The suspension device of the saddled vehicle according to claim 1,
wherein the front wheel-side damper makes the damping force high in non-energization.

3. The suspension device of the saddled vehicle according to claim 1,
wherein the front wheel-side damper makes the damping force low in non-energization.

4. A suspension control device, comprising:
a front wheel-side driving circuit to drive a front wheel-side solenoid valve that adjusts damping force in a front wheel-side damper placed between a vehicle body and a front wheel in a saddled vehicle; and
a rear wheel-side driving circuit to drive a rear wheel-side solenoid valve that adjusts damping force in a rear wheel-side damper placed between the vehicle body and a rear wheel in the saddled vehicle, wherein
a degaussing circuit to degauss a solenoid in the front wheel-side solenoid valve is provided only in the front wheel-side driving circuit.

5. The suspension control device according to claim 4,
wherein the front wheel-side driving circuit includes, with respect to a switch, two switches that are a main switch to adjust voltage applied to the solenoid and a degaussing switch to switch validity and invalidity of the degaussing circuit, and
the rear wheel-side driving circuit only includes, with respect to a switch, a main switch to adjust voltage applied to the solenoid.
